(19) United States
(12) Patent Application Publication
(10) Pub. No.: US 2009/0152375 A1
(43) Pub. Date: Jun. 18, 2009

(54) Fuel injector

(75) Inventors: Karl J. Schmucker, Raeren (BE); Hermann-Josef Laumen, Heinsberg (DE)

Correspondence Address: GIFFORD, KRASS, SPRINKLE,ANDERSON & CITKOWSKI, P.C, PO BOX 7021, TROY, MI, 48007-7021, US

(73) Assignee: Fev Motorentechnik GMBH, Aachen (DE)

(21) Appl. No.: 11/720,342

(22) PCT Filed: Nov. 11, 2005
(86) PCT No.: PCT/EP2005/012099

§ 371 Date: Dec. 2, 2007

(30) Foreign Application Priority Data
Nov. 29, 2004 (DE) 10 2004 057 610.6

(51) Int. Cl. F02M 47/02

(52) U.S. Cl. 239/88; 239/5

(57) ABSTRACT

A fuel injection method according to the invention that utilizes an accumulator principle, particularly a common rail principle, is characterized in that fuel arriving from an accumulator, particularly a common rail, is conveyed to a primary side of the pressure booster at a first pressure such that a secondary side of the pressure booster is subjected to a pressure increase, and in that an opening and closing of an injection nozzle are realized with the pressure in a pressure chamber for the injection nozzle, by displacing a closing element that acts upon the injection nozzle, particularly an injector needle, by means of a hydraulically controlled pressure change.

### CROSS-REFERENCE TO RELATED APPLICATIONS

This application is the United States national phase application of International Application No. PCT/EP05/12099 filed on Nov. 11, 2005 and claiming a priority date of Nov. 29, 2004, which is incorporated herein by reference.

### FIELD OF THE INVENTION

The present invention pertains to a fuel injection method that utilizes an accumulator principle, particularly a common rail principle, as well as to a fuel injection device for a reciprocating internal combustion engine according to an accumulator principle, particularly according to the common rail principle.

### BACKGROUND OF THE INVENTION

WO 01/14713 A1 discloses a fuel injection device in which fuel is injected with a least two different fuel pressures by means of injectors. The fuel injection should be pressure-controlled at the higher fuel pressure in this case. For this purpose, a control chamber of the fuel injection valve features a connection to a line with a fuel pressure. In addition, a pressure booster is arranged upstream of the injection valve and is controlled by a solenoid valve analogous to the injection valve. Due to the proposed device and the method in which this device is used, the injection nozzle is under the pressure of at least the associated common rail at all times.

### SUMMARY OF THE INVENTION

The invention is based on the objective of achieving an improved injection in which, in particular, an injection nozzle can be rapidly opened and closed and the injection can be realized more flexibly such that metering of the quantity to be injected can be improved and an injection sequence can be defined.

This objective is attained with a fuel injection method with the characteristics of claim 1, with a fuel injection device with the characteristics of claim 10, and with a fuel injection device with the characteristics of claim 12. Other advantageous configurations and additional developments are defined in the respective dependent claims.

A fuel injection method according to the invention that utilizes an accumulator principle, particularly a common rail principle, is characterized in that fuel arriving from an accumulator, particularly a common rail, is conveyed to a primary side of the pressure booster at a first pressure such that a secondary side of the pressure booster is subjected to a pressure increase, and in that an opening and closing of an injection nozzle are realized with the pressure in a pressure chamber for the injection nozzle, by displacing a closing element that acts upon the injection nozzle, particularly an injector needle, by means of a hydraulically controlled pressure change.

This makes it possible to achieve an increase in the maximum attainable injection pressure by means of the pressure booster. In addition, the hydraulic control of a pressure change males it possible to rapidly open as well as rapidly close the injection nozzle. The quantity to be injected can furthermore be metered in an extremely precise fashion with minimal pressure changes. It is possible, in particular, to attain injection rates that are comparable to those of conventional pump-injector systems.

Since corresponding pressure drops and pressure increases have very rapid effects due to the hydraulic pressure transmission, this advantage of the pump-injector principle, namely a precisely metered injection sequence, can be combined with the flexibility of a common rail system. Characteristics such as pre-injection and post-injection can be adapted to at least one main injection with respect to the quantity as well as the time, particularly with a hydraulic control of the pressure only. In addition, instead of main injection, a timed injection can also be realized during an injection phase that can be adapted to various operating ranges of the internal combustion engine, for example, with the aid of corresponding characteristic diagrams.

According to a first configuration of the invention, this fuel injection device is connected to the one proposed in WO 01/53688, the full content of which, with respect to the fuel injection device as well as the individual components and methods, is hereby incorporated into this publication by reference. As mentioned above, the pressure booster is preferably arranged between the control valve and the injection nozzle, wherein according to one configuration the hydraulic control of the pressure chamber for the injection nozzle features a direct connection to the control element.

According to another configuration, a pressure in excess of 2000 bar is generated on the secondary side. This can be realized, for example, if a pressure in excess of 1500 bar acts upon the primary side. According to another configuration, a ratio between primary pressure and secondary pressure is adjusted which lies between 1:1.2 and approximately 1:4, preferably between 1:1.8 and approximately 1:3, particularly between approximately 1:1.5 and approximately 1:3. For this purpose, the pressure booster is preferably realized in the form of a piston that features different surface areas on the primary and the secondary side, e.g., as described in the above-mentioned publication WO 01/14713. In this respect, we refer to the disclosure of this publication. It is advantageous for the pressure intensification ratio to be smaller than 3 such that it is possible to realize a small rail volume on the one hand and a small control valve cross section on the primary side as well as a small supply line cross section on the other hand. An advantageous design of the line cross sections can be realized based on a pressure intensification ratio of the pressure booster. Corresponding indications are provided further below with reference to a few examples, wherein these indications, however, are not limited to the respective configuration.

According to another configuration, the pressure chamber is subjected to a second pressure generated on the secondary side, wherein the hydraulically controlled pressure change acts upon the primary side of the pressure booster. This allows a particularly fast reaction between the initiation of a pressure change and the change of an injection behavior. It is particularly preferred for a fuel injection pressure realized by means of the hydraulically controlled pressure change to follow a valve stroke of a control valve immediately.

According to one additional development, a pressure on the secondary side is decreased by discharging fuel into a low-pressure chamber in order to close an injection nozzle. Due to this measure, the required sealing surfaces of the injection system, particularly for closing the injection nozzle on the secondary side, are invariably subjected to pressure for brief periods of time only. This furthermore makes it possible to quickly change the injection sequence and, in particular, to precisely meter the fuel to be injected. If a high pressure continuously acts upon the injection nozzle, leaks could develop in the region of the sealing surfaces between the nozzle and the upper part of the injector. Moreover, if a uniformly high pressure permanently acts upon the injection nozzle, the control and regulation precision of the injected amount, necessary for possibly required injection profiles, would be difficult to realize because it would be necessary to open and close the injection nozzle even faster. The option of decreasing the pressure on the secondary side, in contrast, also makes it possible to realize increasing and decreasing characteristics of injection into die combustion chamber.

In other respects, the method can also be carried out such that the actuating times for the fuel injection can be purposefully shortened with the aid of pressure feedback.

According to another configuration, a control element that is arranged downstream of the accumulator and upstream of the pressure booster is acted upon with the second pressure from the secondary side of the pressure booster. This makes it possible, for example, to also utilize the injection pressure for controlling the fuel injection. A higher metering accuracy can also be achieved in this fashion.

It is furthermore possible to act upon a control element that is arranged downstream of the accumulator and subjected to a control pressure in a control line that is delivered by the accumulator and subsequently influenced with the second pressure from the secondary side of the pressure booster, wherein the control pressure determines the connection of the second pressure to a low-pressure chamber.

According to one additional development, one or more damping volumes, particularly throttle points, are provided in order to at least damp possibly occurring oscillations to such a degree that they do not interfere with the desired injection sequence. For example, an oscillation in a control chamber of the control element and in a pressure supply line can be reduced with a throttle. A throttle can furthermore be provided in order to absorb or at least damp undesirable pressure waves in the fuel injection device.

In addition, one or more throttles can be used to purposefully build up the fuel pressure. This can be used, in particular, for achieving accelerated switching times, for example, with respect to the closing element acting upon the injection nozzle. For example, a throttle point can be connected to an evacuation chamber that is arranged opposite from the injection nozzle is and separated by the closing element. The throttle point is arranged between the evacuation chamber and the low-pressure chamber. It ensures a delayed pressure drop from the evacuation chamber into the low-pressure chamber such that, for example, cavitation can be prevented in the region of the injection nozzle, particularly during closing. The throttle point can simultaneously generate backpressure when the pressure in the evacuation chamber for the injection nozzle is increased, such that a faster response with respect to the displacement of the closing element is achieved.

In order to improve the shaping of the injection sequence, the conventional monotonic voltage control of the first control element could also be replaced with a timed voltage control such that the ensuing second control element, the pressure booster and the injection nozzle are timed in a hydraulically controlled fashion. In this case, the timing is preferably adapted to an operating range.

The invention also proposes a fuel injection device with an accumulator, particularly according to the common rail principle, for a reciprocating internal combustion engine, wherein said fuel injection device features an injection nozzle and an injector part, wherein the injector part has a pressure chamber in which a closing element for closing the injection nozzle is guided, wherein the pressure chamber is connected via a connecting channel to a pressure booster that is arranged downstream of an accumulator, particularly a common rail, and upstream of the pressure chamber, and wherein the valves of the fuel injection device that are arranged downstream of the accumulator and serve to control the fuel flow are, with the exception of a first control element, in particular a valve, controlled hydraulically by the control valve. Due to this control principle, it is not necessary to provide, in particular, two independently controlled adjusting elements in order to control, for example, a pressure booster and an injector needle. On the contrary, a single control element, with the aid of the effective cross sections of lines, components and of other forces such as, for example, spring forces and hydraulic forces, makes it possible to realize the desired injection profile.

The accumulator consists of a pressure accumulator in which the fuel is under pressure. The accumulator can be supplied with fuel continuously or a discontinuously, for example, with the aid of a pump system. The accumulator can be connected, for example, to only one injection nozzle or to several injection nozzles by means of corresponding control lines in order to respectively supply these injection nozzles with fuel. The term “accumulator” therefore also includes, in particular, the injection systems for Otto cycle as well as for Diesel cycle engines known as common rail systems.

A corresponding electronic control of the control element, for example, makes it possible, namely in connection with an engine control to immediately react to the particular load status of the reciprocating internal combustion engine with a suitable fuel injection. An improved, and in particular more flexible, injection profile is achieved if the pressure chamber is connected to a low-pressure chamber via a pressure relief connection. The low-pressure chamber may consist, for example, of a tank or another container or a large-volume line capable of lowering the pressure at the injection nozzle by taking up fuel volumes. The fuel flow to be controlled is preferably so small that no back pressure occurs in a low-pressure system that comprises the low-pressure chamber. The low-pressure chamber or the low-pressure system is respectively realized, in particular, in the form of an “unpressurized” system, i.e., the pressure in the system is at least close to the ambient pressure according to one configuration. According to one additional development, the pressure also lies far below the ambient pressure. The pressure preferably is chosen such that vapor bubbles develop in the fuel. These vapor bubbles can damp waves. This furthermore makes it possible to homogenize a fuel flow.

The invention also proposes a fuel injection device according to an accumulator principle, particularly according to the common rail principle, for a reciprocating internal combustion engine which features an injection nozzle and an injector part, wherein the injector part has a pressure chamber in which a closing element for closing the injection nozzle is guided, wherein the pressure chamber is connected via a connecting channel to a pressure booster that is arranged downstream of an accumulator, particularly a common rail, and upstream of the pressure chamber, and wherein the pressure chamber is connected to a low-pressure chamber via a pressure relief connection.

According to one additional development, the control elements that are arranged downstream of the accumulator and serve to control the fuel flow are, with the exception of a control valve, controlled hydraulically by the control valve.

According to another configuration, the pressure booster features a piston with a primary side and a secondary side, wherein the secondary side is connected to the pressure chamber via the connecting channel and to a control element arranged upstream of the low-pressure chamber via the pressure relief line. Such an arrangement makes it possible to achieve a very precise injection profile. It allows a direct shaping of an injection profile, wherein idle times, wave processes, inert masses and other interfering factors are prevented.

A device of this type is particularly advantageous if injection pressures in excess of 2000 bar are achieved. For example, if injection pressures between 2500 bar and approximately 3000 bar are realized, the seals are subjected to particularly high stresses. A permanent stress on all components, particularly on at least the seals, is prevented due to the pressures made possible by the pressure booster, as well as the option of relieving the fuel pressure on the secondary side. This in turn makes it possible to extend the service life of this fuel injection device and to prevent leaks.

According to one additional development, an evacuation chamber for the injection nozzle features a connecting line to a throttle that is arranged upstream of a low-pressure chamber. The throttle can have the function of suppressing oscillations in the evacuation chamber and in the lines that are connected to the evacuation chamber. However, the throttle can also damp a pressure wave, and in particular, cause a pressure build-up. This is preferably utilized for achieving a faster control of the injection valve.

It would also be conceivable for the pressure relief connection between the pressure chamber and the low-pressure chamber to run via the evacuation chamber for the injection nozzle. This makes it possible to realize a pressure drop on the secondary side. The secondary side can be simultaneously utilized to control the injection valve. This in turn makes it possible to shorten the control time for the fuel injection device and therefore to improve the accuracy with respect to the volume to be injected as well as the injection sequence of this volume. An injection profile comprises, for example, a pre-Injection and/or post-injection that can be precisely metered with this fuel injection device.

According to another configuration, an adjusting device is provided for raising and lowering an accumulator pressure, preferably a common rail pressure, in dependence on the load status of the reciprocating internal combustion engine. This makes it possible, for example, to realize the injection nozzle with smaller bores, particularly during the partial load operation. Smaller bores can have diameters, in particular, of 0.09 mm or less. Based on a displacement of 0.5 L per cylinder or more, the bore has a diameter of 0.15 mm or less. According to one configuration, the pressure in the common rail system is reduced during partial load operation of the reciprocating internal combustion engine. However, the pressure booster is able to generate a pressure on the secondary side that makes available a sufficient quantity to be injected despite the smaller bore sizes. An improved atomization of the injected fuel is achieved in this fashion. According to another configuration, the pressure in the common rail system is increased again during full load operation, for example, in a range between 80% and 100% of the output of the reciprocating internal combustion engine. The pressure upstream of the pressure booster can then be controlled such that it makes available, for example, an injection pressure that is adapted to partial load operation. However, it can also be realized such that an even higher pressure, and therefore greater volume, is made available for the injection.

The pressure booster is preferably controlled hydraulically. This eliminates another adjusting element that needs to be actuated electromechanically or electrically and controlled in dependence on the control element. According to another configuration, an adjusting element, particularly a hydraulically controlled valve, is intermediately arranged between the low-pressure chamber and the pressure chamber and creates a connection with the evacuation chamber. This makes it possible for the pressure chamber to decrease or increase its pressure depending on the position of the controlled valve. If the valve is closed, the pressure in the pressure chamber is increased by the pressure booster if the primary side is acted upon with an appropriate pressure. If the valve is opened, fuel can flow from the pressure chamber into the evacuation chamber via the valve and from the evacuation chamber to the low-pressure chamber. This results in a pressure decrease in die pressure chamber that advantageously affects at least the closing of the injection nozzle.

The injection nozzle used can consist of a hole-type nozzle. The nozzle can have a variable cross section. The nozzle can also feature, in particular, one or more rows of holes that are respectively opened or closed at different times or during different strokes of the closing element. According to one configuration, a nozzle is used in which needles with different cross sections are nested into one another. These movable needles can close and open different nozzle openings in different positions. According to another configuration, other nozzle geometries such as, for example, slots or the like, are provided.

The fuel injection device is not only suitable for passenger cars, but also for utility vehicles including locomotives and ships or stationary motors. In particular, with respect to a hydraulic control it is advantageous for the lines and line cross sections used to be adapted to the respective motor. For this purpose, preferred line cross sections and valve cross sections with which, for example, the hydraulic control can be performed. According to one configuration, the pressure booster has a diameter between 4 mm and 6.5 mm on the secondary side. In contrast, the pressure booster has a diameter on the primary side that preferably lies between 7 mm and 11 mm. According to one configuration, the pressure booster is realized in the form of a piston with a stroke between 4 mm and 10 mm, preferably between 4 mm and 7 mm. The line diameter used depends once again on whether a high throughput must be ensured. If this is the case, it is preferred to use a line diameter of no less than 3 mm, wherein the diameter may, however, also become narrower over the length of the line. A certain minimum diameter may be required in other line regions. This minimum diameter is, for example, at 1.5 mm, particularly at least 2 mm. For example, the line leading to the pressure chamber preferably has a line cross section, for example, of at least 1.5 mm. An outgoing line of the accumulator, preferably the common rail, once again has a line cross section of no less than 3 mm, particularly when it is used in a passenger car.

### BRIEF DESCRIPTION OF THE DRAWINGS

Other advantageous configurations are described with reference to the following additional developments. However, the respective characteristics are not limited to these particular additional developments. On the contrary, these characteristics may also form other configurations, particularly in connection with the characteristics described above. The figures show:

FIG. 1, a first fuel injection device;

FIG. 2, a second fuel injection device;

FIG. 3, a third fuel injection device;

FIG. 4, an example of an injection sequence for an operating point with the progression of various parameters over the course of an injection phase;

FIG. 5, an configuration example of a fuel injector, and

FIG. 6, an enlarged detail of a control element according to FIG. 5.

### DETAILED DESCRIPTION OF THE PREFERRED EMBODIMENTS

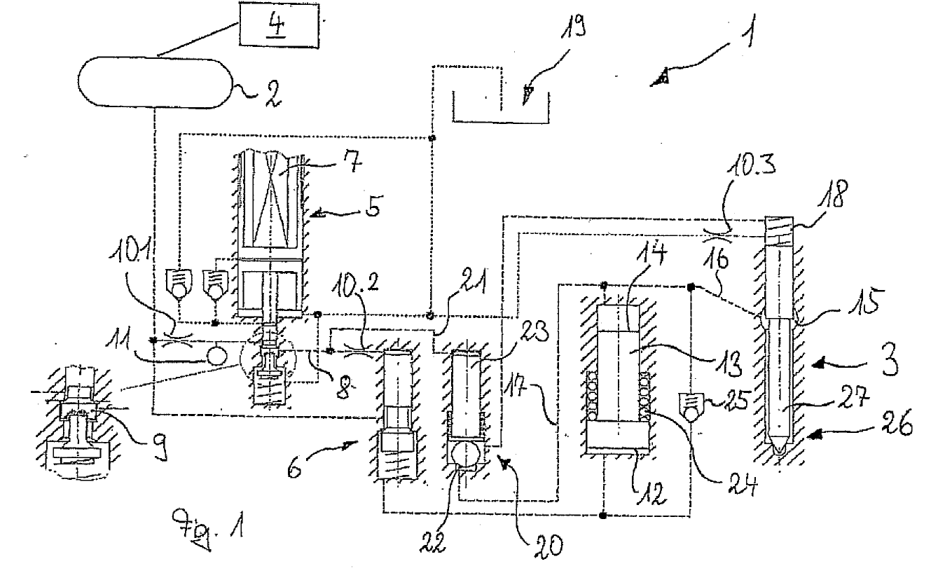

FIG. 1 shows a first fuel injection device 1. The first fuel injection device 1 features an accumulator 2 that supplies one or more injection nozzles 3 with fuel. The accumulator 2 features an adjusting device 4 that serves to raise and lower the pressure in the accumulator 2. The adjusting device is preferably connected to a not-shown engine control that delivers signals in dependence on the load status of an internal combustion engine and therefore the required pressure in the accumulator 2. One or more components of the fuel injection device 1 can also be directly or indirectly connected to the engine control, for example, via one or more control devices. However, the required sensors and signaling lines are not illustrated in the figure.

The fuel is conveyed under pressure from the accumulator 2 to a first control element 5 and a second control element 6. The function of the first control element is described, for example, in WO 01/53688, to which this application refers in this respect. The first control element 5 forwards the fuel to the second control elements 6. This is realized by controlling the first control element 5 accordingly. For this purpose, the first control element 5 is equipped, for example, with an actuator 7 that is controlled by a control device or the engine control. Depending on the control of the actuator 7, a fuel line 8 is unblocked by means of a first piston 9 that is illustrated in an enlarged fashion. A throttle 10.1, 10.2 is preferably arranged upstream of at least the first control element 5 and/or the second control element 6. The throttle damps possible oscillations in the lines that may be caused, for example, by adjustments of the first control element 5 or second control element 6. In addition, the throttles 10.1, 10.2 can generate a backpressure such that, for example, the pressure of the second control element 6 can be relieved and its position can be influenced. The throttles 10.1, 10.2 assist in preventing the formation of bubbles and cavitation damage. It has furthermore proved advantageous to arrange a smoothing or compensating volume 11 upstream of the first control element 5 in order to damp possible pressure changes or oscillations.

The function of the second control element 6 is also described, for example, in WO 01/53688, to which this application refers in this respect, wherein this second control element controls a pressure that acts upon a primary side 12 of a pressure booster 13. The pressure booster 13 preferably features a reciprocating piston that is supported, for example, by means of springs. The pressure booster 13 features a primary side 12 that has a larger cross-sectional surface area than a secondary side 14 situated opposite from the primary side 12. Fuel is conveyed from the secondary side 14 to a pressure chamber 15 of the injection nozzle 3. The fuel can be injected into a not-shown cylinder from the injection nozzle 3 via the pressure chamber 15. In addition to the connecting channel 16, a pressure relief connection 17 is also connected to the secondary side 14 of the pressure booster 13, wherein said pressure relief connection leads to an evacuation chamber 18 and from the evacuation chamber to a low-pressure chamber 19. Via pressure relief connection 17, the fuel originating from the secondary side 14 preferably first enters a third control element 20 that is controlled hydraulically and releases the connection to the low-pressure chamber 19.

The third control element 20 preferably serves as a pressure relief valve. In this case, the third control element 20 is designed, for example, such that the ratio between a surface 22 of the third control element 20 which is subjected to pressure and an end face of a control piston 23 approximately corresponds to the reciprocal value of the pressure increase realized with the pressure booster 13, and therefore the ratio of the secondary side to the primary side. Consequently, a pressure in a control line 21 corresponds to the pressure on the primary side 12 of the pressure booster 13. This means that the third control element 20 only opens, in particular, at the end of a fuel injection into the cylinder chamber. The fluid volume being injected within a very short period of time can be used subject the closing element 27 to additional pressure, particularly a pressure pulse, and thus closing this element more rapidly. The throttle 10.3 between the evacuation chamber 18 and the low-pressure chamber 19 serves to improve this pressure effect. After an injection process, the pressure booster 13 is returned into its starting position by a spring 24, with the connecting channel 16 being filled with fuel by means of a check valve 25. The springs arranged in the individual adjusting elements such as the valves, as well as the effective surface areas, are adapted to one another in such a way that control of the first control element 5 makes it possible to realize a fuel injection process with only the combined effect of compressive forces hydraulically transmitted to the individual components.

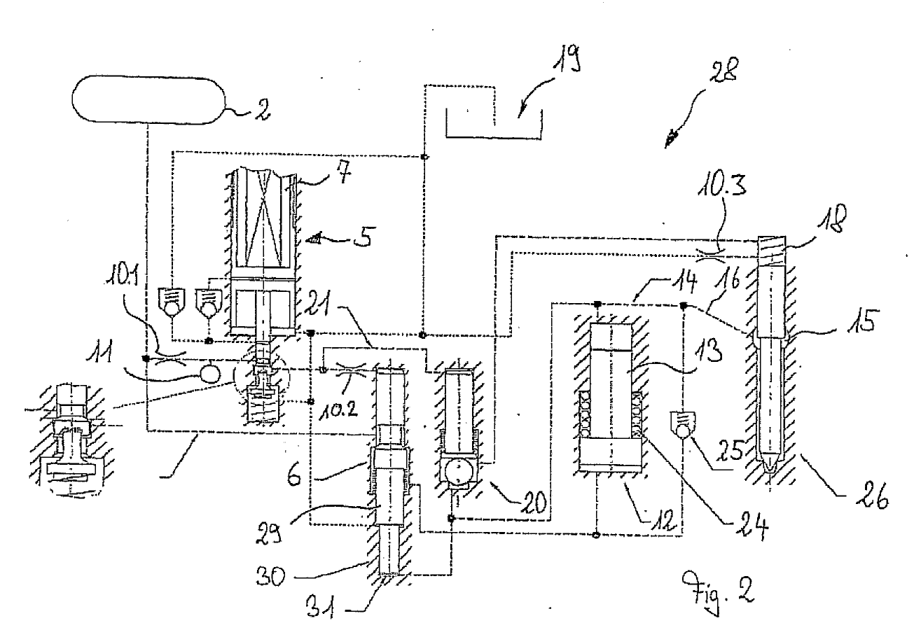

FIG. 2 shows a second fuel injection device 28 that consists of essentially the same components as the first fuel injection device system 1 according to FIG. 1, with these components fulfilling the same functions as in the first configuration. In this respect, identical reference symbols have been used. The second fuel injection device 28 represents another configuration, in which the second control element 6 is provided with a valve body 29 that is realized such that pressure originating from the primary side 12 of the pressure booster 13 at least exerts approximately no force upon the valve body 29. Instead, an additional compensating force is exerted that is preferably generated by means of a compensation piston 30 in the configuration shown. A control side 31 of the compensation piston 30 is connected to the connecting channel 16 that serves as an injection line. This results in a force acting upon the valve body 29 in the closing direction. The ratio between the control surfaces of the valve body 29 and of the compensation piston 30 preferably corresponds to the ratio of the pressure increase of the pressure booster 13. One advantage of this configuration can be seen in that an injection pressure is utilized to cause a reaction of the second control element 6 that serves as the control body, rather than a pressure from the primary side of the pressure booster 13 as is the case in the configuration according to FIG. 1. In comparison with FIG. 1, this makes it possible to additionally increase the metering accuracy of the injection realized by means of the injection nozzle 3. In addition to the throttles shown in the figure, other throttles can be provided to suppress possible oscillations in the system according to FIG. 2.

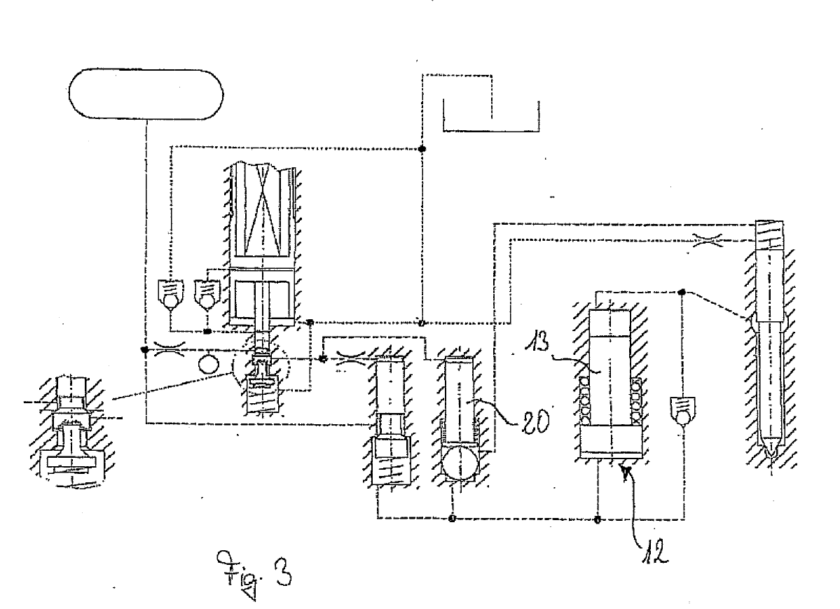

FIG. 3 shows a third fuel injection device 32. In this configuration, the pressure on the primary side 12 of the pressure booster 13 is relieved by means of the third control element 20. This configuration can be utilized in a particularly advantageous fashion if larger quantities of fuel need to be added in a metered fashion.

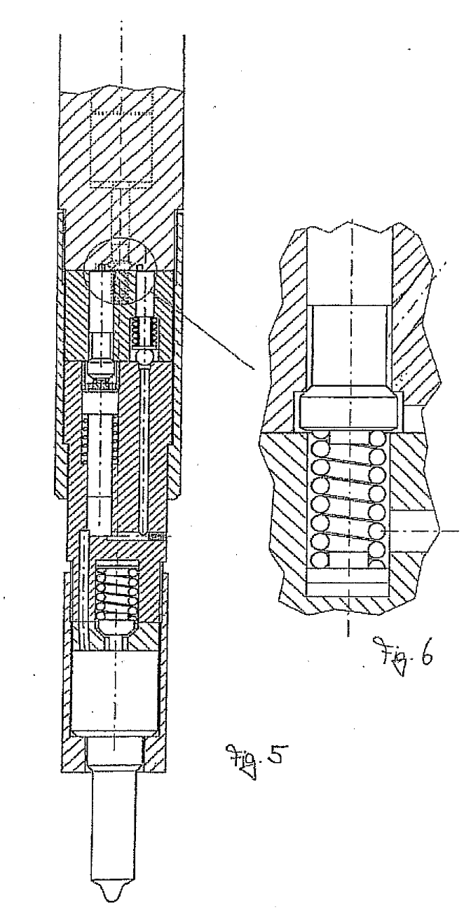

The fuel injection devices shown in FIGS. 1-3 can be assembled, in particular, in the form of a single module installed on the cylinder of an internal combustion engine. In this respect, the present application refers to WO 01/53688, in which such a basic design is described in detail. A fuel injection device of this type that is assembled in the form of a single module is also illustrated in FIG. 5. It would also be conceivable for the fuel injection device to feature components that are arranged separately of one another. Another particularly preferred application of the fuel injection device is for test stands used to carry out basic research with injection pressures of at least 2000 bar, particularly in excess of 2500 bar.

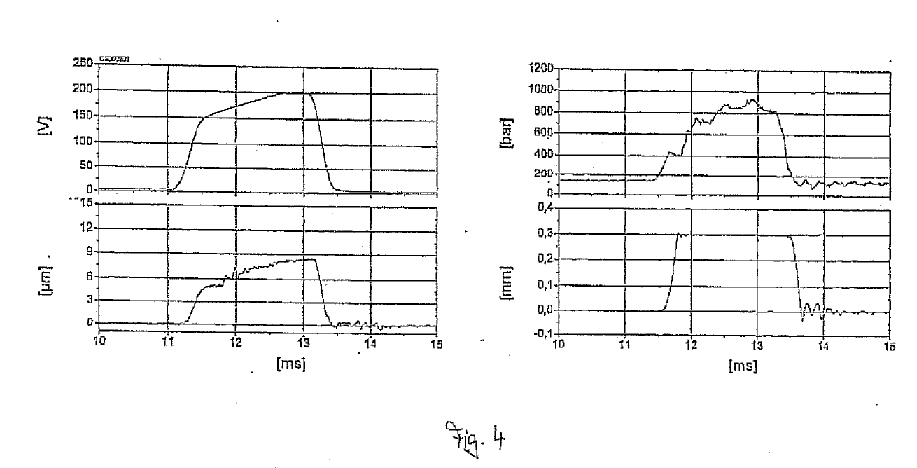

FIG. 4 shows an example of an injection sequence for an operating point with the progression of various parameters over the course of an injection phase. According to this figure, the fuel injection device makes it possible to realize a specific profile of the injection volume as a function of time by controlling the first control element only. The same injection phase time interval is illustrated on the X-axis for all parameters shown. The first control element that consists, for example, of a piezo-controlled actuator is operated by changing the applied voltage. The voltage is indicated in volts. Depending on this voltage, the valve of the first control element opens as indicated in μm. Since the components to be subsequently actuated react hydraulically and therefore without delay, the needle of the injection valve is raised almost simultaneously, with the pressure increase. Since the pressure on the needle seat is already increased before the needle valve initially opens, a directly metered quantity of fuel can be supplied into the combustion chamber or the channel when the valve opens. This means that less than 0.8 ms elapse between a voltage change on the actuator and the beginning of the injection. This rapid and immediate action also makes it possible to adjust the injection pressure by purposefully raising and lowering of the valve of the first control element. If the voltage is lowered again, the pressure is also lowered almost immediately, and the pressure change causes the needle stroke to change within a time interval of less than 0.7 ms.

FIG. 5 shows an configuration example of a fuel injector, and FIG. 6 shows an enlarged detail of the first control element according to FIG. 5. With the exception of the accumulator 2, the adjusting device 4 and the low-pressure chamber 19, the fuel injector features the components illustrated in FIG. 1 that are accommodated in a single module. For this purpose, the individual components feature pre-fabricated channels such that only a few processing steps need to be performed on the fuel injector when the individual components are assembled and joined. A very compact fuel injector can be realized due to the accommodation of all individual components in a single module.

1. A fuel injection method that utilizes an accumulator principle, said method comprising:
supplying fuel from an accumulator (2) such that the fuel is conveyed to a primary side (12) of a pressure booster (13) at a first pressure such that a secondary side (14) of the pressure booster (13) is subjected to a pressure increase; and
opening and closing an injection nozzle (3) arc with a pressure in a pressure chamber (15) of the injection nozzle (3). the opening and closing of the injection nozzle (3) realized by the displacement of a closing element (27) that acts upon the injection nozzle (3), the displacement of the closing element (27) realized by a hydraulically controlled pressure change.

2. The method according to claim 1, wherein the pressure chamber (15) is subjected to a second pressure that is generated on the secondary side (14) and the hydraulically controlled pressure change acts upon the primary side (12) of the pressure booster (13).

3. The method according to claim 1 wherein a fuel injection pressure follows immediately after a valve stroke of a control valve due to the hydraulically controlled pressure change.

4. The method according to claim 1, wherein a pressure on the secondary side (14) is reduced for the closing of the injection nozzle (3) by discharging fuel into a low-pressure chamber (19).

5. The method according to claim 1, wherein a control element (5; 6; 20) that is arranged downstream of the accumulator (2) and upstream of the pressure booster (13) is acted upon with the second pressure on the secondary side (14) of the pressure booster (13).

6. The method according to claim 2, wherein a control element (20) arranged downstream of the accumulator (2) is acted upon by a control pressure in a control line (21) that is delivered by the accumulator, the control element being subsequently influenced, wherein the control element is also acted upon by the second pressure on the secondary side (14) of the pressure booster (13), and wherein the control pressure determines the connection of the second pressure to a low-pressure chamber (19).

7. The method according to claim 5 further including one or more damping volumes operable to damp occurring oscillations.

8. The method according to claim 3, wherein the timing of fuel injection during an injection phase is hydraulically controlled.

9. The method according to claim 8, wherein the timing is adapted to an operating range.

10. A fuel injection device (1; 28; 32) with an accumulator for a reciprocating internal combustion engine, said device comprising:
an injection nozzle (3);
an injector part (26), said injector part having a pressure chamber (15) in which a closing element (27) for closing the injection nozzle (3) is guided;
said pressure chamber (15) being connected via a connecting channel (16) to a pressure booster (13) that is arranged downstream of an accumulator (2) and upstream of said pressure chamber (15);
valves of said fuel injection device, said valves arranged downstream of an accumulator (2) and operable to control fuel flow; and
a control valve (5) operable to control said valves, with the exception of a first control element (5), hydraulically.

11. The fuel injection device (1; 28; 32) according to claim 10, wherein said pressure chamber (15) is connected to a low-pressure chamber (19) via a pressure relief connection (17).

12. A fuel injection device (1; 28; 32) with an accumulator for a reciprocating internal combustion engine, said device comprising:
an injection nozzle (3); and
an injector part (26) having a pressure chamber (15) in which a closing element (27) for closing the injection nozzle (3) is guided, said pressure chamber (15) being is connected via a connecting channel (16) to a pressure booster (13) that is arranged downstream of an accumulator (2) and upstream of the pressure chamber (15);
said pressure chamber (15) being connected to a low-pressure chamber (19) via a pressure relief connection (17).

13. The fuel injection device (1; 28; 32) according to claim 12, wherein, with the exception of a first control element (5), said control elements of said fuel injection device arranged downstream of said accumulator (2) and operable for controlling a fuel flow, are hydraulically controlled by said control element (5).

14. The fuel injection device (1; 28; 32) according to claim 12, wherein said pressure booster (13) has a piston with a primary side (12) and a secondary side (14), said secondary side (14) being connected to said pressure chamber (15) via said connecting channel (16) and to a control element arranged upstream of said low-pressure chamber (19) via said pressure relief connection (17).

15. The fuel injection device (1; 28; 32) according to claim 12, wherein an evacuation chamber (18) for said injection nozzle (3) has a connecting line to a throttle (10) that is arranged upstream of said low-pressure chamber (19).

16. The fuel injection device (1; 28; 32) according to claim 12, wherein said pressure booster (13) is operable to increase an input pressure by a factor of approximately 1.5 to approximately 3.

17. The fuel injection device (1; 28; 32) according to claim 12, wherein said pressure relief connection (17) between said pressure chamber (15) and said low-pressure chamber (19) extends via an evacuation chamber (18) for the said injection nozzle (3).

18. The fuel injection device (1; 28; 32) according to claim 12, further comprising an adjusting device (4) operable for raising and lowering an accumulator pressure in dependence on a load status of said reciprocating internal combustion engine.

19. The fuel injection device (1; 28; 32) according to claim 12, wherein said pressure booster (13) is controlled hydraulically.

20. The fuel injection device (1; 28; 32) according to claim 17, wherein said control element (5; 6; 20) is intermediately arranged between the said low-pressure chamber (19) and said pressure chamber (15), said control element creating a connection with said evacuation chamber (18).

21. The fuel injection device (1; 28; 32) according to claim 14, wherein pressure on said secondary side (14) of said pressure booster (13) lies above 2000 bar.

22. A fuel injection device (1; 28; 32) comprising: a fuel injection pressure; and a control valve, said fuel injection pressure immediately follows a valve stroke of said control valve, said control valve being actuated by means of a hydraulically controlled pressure change.
